(19) United States
(12) Patent Application Publication
(10) Pub. No.: US 2010/0321213 A1
(43) Pub. Date: Dec. 23, 2010

(54) ARRANGEMENT FOR COMMUNICATION AND TRAVEL FOLLOW-UP

(76) Inventors: Jari Mattila, Helsinki (FI); Arto Pitsinki, Helsinki (FI); Mika Järvinen, Helsinki (FI); Chandika Chandrasekeram, Helsinki (FI)

Correspondence Address: BIRCH STEWART KOLASCH & BIRCH, PO BOX 747, FALLS CHURCH, VA, 22040-0747, US

(21) Appl. No.: 12/747,149

(22) PCT Filed: Dec. 9, 2008
(86) PCT No.: PCT/FI08/50720

§ 371 Date: Sep. 7, 2010

(30) Foreign Application Priority Data
Dec. 10, 2007 (FI) 20075892

(51) Int. Cl. G08G 1/123

(52) U.S. Cl. 340/989

(57) ABSTRACT

The object of the invention is an arrangement for communication and location tracking, which comprises at least one or more server apparatuses and a plurality of remote terminals, the position of which is arranged to be located by satellites and which comprises at least means for sending information to the server apparatus. The means in the remote terminals are equipped to send information concerning the position of the remote terminal and other information collected by the remote terminal wirelessly to the server apparatus, and the server apparatus is provided with at least connection means for receiving information coming from the remote terminal, with a database for recording information coming from the remote terminal, with processing means for processing information sent by the remote terminal, and also with a control system for coordinating and controlling the different functions of the arrangement for communication and location tracking.

The object of the invention is an arrangement for communication and location tracking as defined in the preamble of claim 1.

The object of the invention is generally speaking an arrangement for communication and location tracking, which comprises a plurality of remote terminals, disposed in a stationary position or portable, which are equipped to identify their own position by means of satellite positioning and if necessary to collect the kind of relevant information that has, or may have, an effect on the aforementioned identified position. The remote terminals are also equipped to send position information and, if so desired, also the aforementioned collected information via a public network to the server of the arrangement for processing. The remote terminals are also fitted if necessary to record the position information and the collected information in their own memories as well as, if necessary, to process the aforementioned information in their own processing means. In addition, the remote terminals of the arrangement are equipped to receive information via a public network.

The location tracking of vehicles and other moving objects, as also of people, is performed for numerous different reasons. Location tracking can be used e.g. from certain places, such as from large advertising billboards, to determine the vehicles driving past and to count the number, for tracking and scheduling the routes of buses, for locating taxis and for indicating the nearest taxi to an orderer, and also for tracking the route of an individual vehicle and determining the length of the journey traveled. The lattermost function is well suited e.g. to implementing a mileage allowance system. Correspondingly, calculation of the number of vehicles can also be utilized to identify congestions and for the decongestion of them as well as to track the emissions of vehicles and e.g. to locate where there are a lot of vehicles in the same area at any given time owing to congestion and to calculate how many of these vehicles cause an emissions impact in each place at any given time. Likewise the location tracking arrangement according to the invention can be used suitably adapted e.g. in connection with freight to ascertain the route and location of goods, to ascertain the whereabouts of stolen vehicles and also to ascertain the whereabouts of children. For example, in large shopping centers a lost child can be located on the right floor very easily by means of the system according to the invention. Joggers and other people on the move can also ascertain their own routes and positions by means of the arrangement according to the invention by using a portable remote terminal fitted for this purpose.

One problem is that with prior-art solutions it has not been possible to develop systems to viably implement the tracking functions described above. For example, the wireless connections needed in these types of tracking systems, such as WLAN connections, would not work reliably, but instead owing to their construction would jam very quickly if e.g. a number of vehicles provided with remote terminals connected to a WLAN network were close to each other, exactly as they would be in the congestion situation mentioned above.

According to prior art neither does e.g. an apparatus for implementing a satellite-based automatic mileage allowance system exist, but instead the kilometers driven for which reimbursement is desired are entered by hand either onto a paper form or into a computer program, from where the information is transferred e.g. to the person handling travel expense reports, who checks the information and pays the reimbursement sum claimed to the account of the applicant. In large companies many of these types of mileage allowance claims are handled daily, so that handling takes a lot of work time and in addition there is the danger that human error will occur in the handling.

The purpose of this invention is to eliminate the aforementioned drawbacks and to achieve a simple and inexpensive arrangement for communication and location tracking, which enables essentially real-time wireless connections fir for use from moving vehicles as well as from other moving objects to public networks and back, and thus the onward delivery of location information and other collected information connected to the use of the vehicle or to the moving object for processing and, correspondingly, delivery of information necessary to the vehicle or to the moving object back to the vehicle or other moving object.

In this case one particular purpose of the invention is e.g. monitoring congestions and the impact of emissions on the environment by means of the location tracking of vehicles and e.g. when the emissions impact rises to be too great in congested locations, guiding vehicles to travel other routes before they encounter the congestion. Another particular purpose of the invention is to automate the handling of mileage allowance claims and thereby both to speed up the aforementioned handling and to reduce the errors occurring in the handling. Additionally, one objective of the invention is to enable other functions related to location tracking, such as the utilization of the position information and route information of vehicles and other moving objects for different functions. Yet another objective of the invention is also to enable communication and the routing of communication between moving vehicles as well as the transmission of telecommunications from a vehicle, or from a remote terminal accompanying some other moving object, via at least one vehicle that is close enough, or via a remote terminal accompanying some other moving object, to a public network and back to the vehicle or other moving object. The arrangement for communication and location tracking according to the invention is characterized by what is disclosed in the characterization part of claim 1. Other embodiments of the invention are characterized by what is disclosed in the other claims.

An advantage of the arrangement for location tracking according to the invention is that the wireless connections of the arrangement withstand a large amount of simultaneous wireless connections without jamming, in which case particularly in e.g. congestions it is possible to track the amount of vehicles and the emissions impact caused by them, and also when the emissions impact threatens to rise too high to guide the vehicles to use other routes. Another advantage, among others, is that the arrangement for location tracking according to the invention enables the automated calculation of mileage allowance, which in this case is rapid and essentially few errors occur. A further advantage is possible utilization of other functions, such as route tracking and location tracking as well as wireless telecommunications in the same connection. One advantage is also versatile and flexible network usage, wherein a vehicle or a portable remote terminal itself can be a transmitting link of the network with respect to other vehicles or portable terminals. One advantage is also the diversified range of usage. As mentioned above, with the arrangement according to the invention it is possible to find lost people, stolen vehicles, freight lost in transport, etc. Another advantage is the functioning of the remote terminals according to the invention as routing links. In this case a mobile phone, PDA apparatus or some other mobile apparatus in Bluetooth connection with a remote terminal or provided with the functions of a remote terminal can be in connection with a public network, although there would not be a normal phone connection nor a direct connection to a public network with it at all. It is sufficient when a mobile phone or mobile apparatus owing to the functions of the remote terminal makes a connection with a remote terminal according to the invention somewhere in the vicinity irrespective of whether the aforementioned remote terminal is in some vehicle, accompanying a moving person as a separate apparatus or integrated directly into a mobile phone, PDA apparatus or some other mobile apparatus.

In the following, the invention will be described in more detail by the aid of one of its embodiments with reference to the attached drawings, wherein

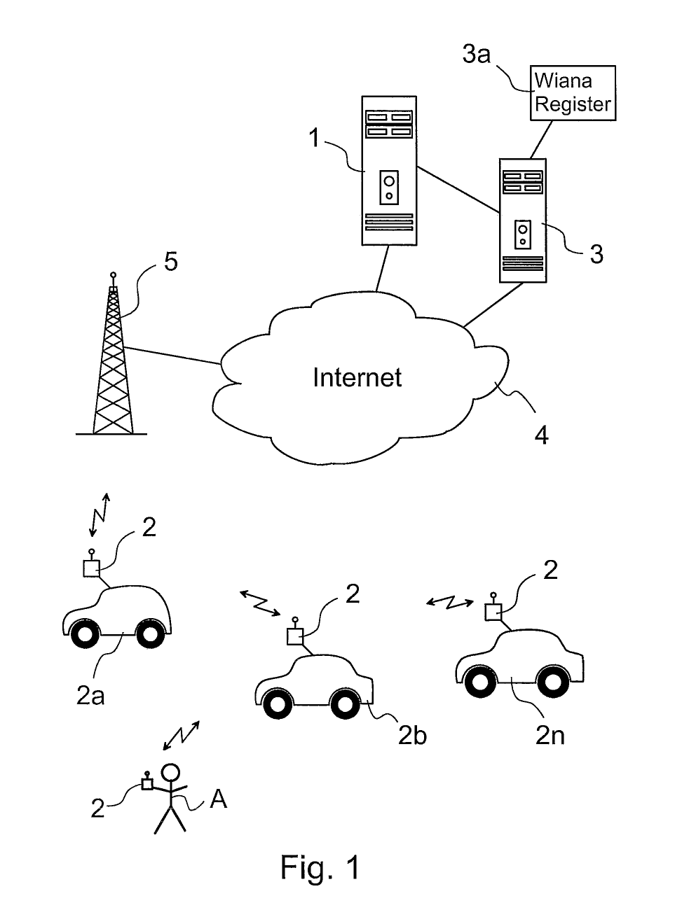

FIG. 1 presents a simplified diagrammatic view of one embodiment of the arrangement according to the invention,

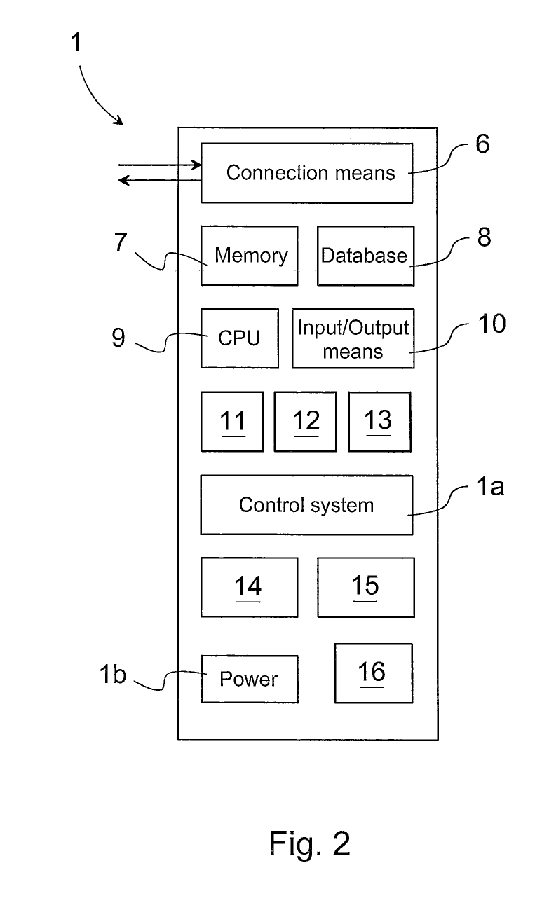

FIG. 2 presents a simplified diagrammatic view of one server used in the arrangement according to the invention and

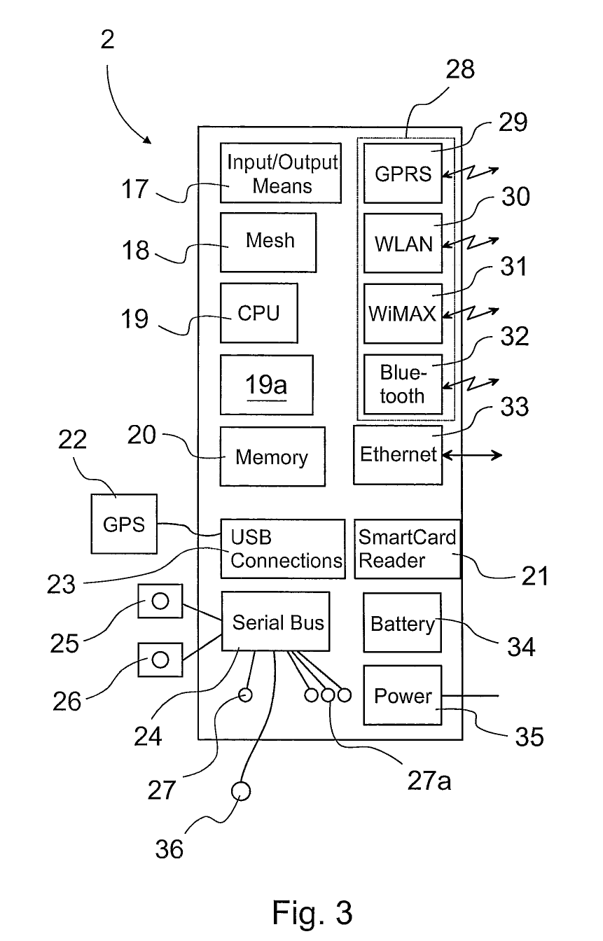

FIG. 3 presents a simplified diagrammatic view of one remote terminal used in the arrangement according to the invention.

A wireless network solution comprising remote terminals 2 and servers 1 that function as connection means, built on an essentially stable operating system, e.g. Linux or corresponding, such as a routing network utilizing wireless MESH technology, is connected to the arrangement according to the invention as one part of it. The solution according to the invention, owing to MESH technology, is provided with means, by the aid of which the dropped information of one connection to a remote terminal is transmitted automatically via the other apparatuses in the area that belong to the system, such as other remote terminals. In addition, the arrangement according to the invention is self-organizing, automatically updating and does not require expensive additional servers. Owing to its mode of operating, it is easy to connect additional properties to the arrangement according to the need of the customer. The arrangement according to the invention supports e.g. wireless WLAN, Bluetooth, WiMAX and GPS technologies and it is easy to install support into it also for any other wireless technology whatsoever.

For safeguarding identification and connections as well as for performing system updates, the remote terminals and servers of the arrangement are entered into a Wiana register, the properties of which comprise, among others, the enabling of internal P2P connections of the wireless MESH network. In this case the internal connections and data transfers of the wireless MESH network do not stress Internet connections. The apparatuses using the wireless MESH network can well be disposed on a mobile platform, in which case they are usable e.g. when carried by a person on the move, in automobiles, on trains, on ships and even on planes.

FIG. 1 presents a simplified diagrammatic view of one embodiment of the arrangement according to the invention. The arrangement comprises at least one server apparatus 1 that functions as an administration server, via which the different functions of the arrangement are administered. Additionally the arrangement comprises a plurality of remote terminals 2 in connection with the server apparatus 1 via a public network connection, such as the Internet 4 or corresponding network, as well as a Wiana sever 3 or corresponding authority connected to the system, which has the right to distribute and manage and also update the wireless network addresses. An individualized identification is given in the Wiana server 3 in the server 3 to each remote terminal 2 in the Wiana register 3a and the same identifications of the remote terminals 2 are given also to the administration server 1 such that the server 1 identifies each remote terminal 2.

Each remote terminal 2, which can be e.g. accompanying a moving person or in a moving vehicle, is in wireless connection with the server 1 via the MESH network or other network that enables a wireless network connection at the time of contact, such as a telecommunications network that allows a GPRS connection or corresponding connection, or some other corresponding network. In the situation according to FIG. 1 one vehicle 2a is in wireless connection with the base station 5, via which there is a connection through the Internet network 4 to the administration server 1. The other vehicles 2b-2n provided with a remote terminal 2 are not in wireless connection directly with the base station 5 in the situation according to FIG. 1, but are however in wireless connection with each other via the MESH network and the remote terminal 2 of at least one vehicle 2b is via the MESH network in wireless connection with the remote terminal 2 of the vehicle 2a, which functions as a routing link to the base station 5, in which case there is a wireless connection to the administration server 1 from also the other remote terminals 2 that are in wireless connection with each other via the MESH network. All of the vehicles 2b-2n therefore do not need to be in direct connection with the vehicle 2a, but instead it is sufficient when the remote terminals 2 of the different vehicles 2b-2n form between them the type of network wherein the remote terminal 2 of each vehicle 2b-2n has contact along some route to the remote terminal 2 of the vehicle 2a.

FIG. 1 presents as an example also e.g. one person A moving on foot, who has with him/her one portable remote terminal 2. The aforementioned portable remote terminal can be the same type as the remote terminals 2 in the vehicles 2a-2n or it can be in some respects different. In its main functions, however, the portable so-called mobile remote terminal 2 is however similar to the remote terminals 2 that are fixed to the vehicles 2a-2n. The portable remote terminal 2 is e.g. a small apparatus, fitting into a pocket, comprising essentially the same positioning functions, memory functions, processing functions and communication functions as the remote terminals 2 disposed in the vehicles 2a-2n. The remote terminal 2 also comprises at least connection means, by the aid of which it can be in wireline connection or wireless connection with a mobile phone, PDA apparatus or some other mobile apparatus of a person carrying the remote terminal 2 along with him/her. The wireless connection is implemented e.g. with a Bluetooth connection.

In the solution according to one embodiment the portable remote terminal 2 is connected to a separate GPS apparatus or corresponding satellite positioning apparatus in essentially the same way as the remote terminals 2 disposed in the vehicles 2a-2n. According to a second embodiment the GPS function is integrated directly into a portable remote terminal 2.

Yet another preferred embodiment of the invention that can be mentioned comprises remote terminal functions integrated into a mobile phone, in which case a mobile phone, PDA apparatus or some other mobile apparatus functions at the same as a linking and routing remote terminal enabling connection to e.g. a wireless MESH network. In this case at least the network function means 18 described in more detail in FIG. 3, or means corresponding to them, are integrated into the mobile phone, PDA apparatus or some other mobile apparatus for connecting the mobile phone, PDA apparatus or some other mobile apparatus that functions as a remote terminal 2 to a wireless MESH network or to a corresponding network.

In the situation according to FIG. 1 the person A is in a mobile MESH connection to the remote terminal 2 of the vehicle 2b and, transmitted onward by it, to the remote terminal 2 of the vehicle 2a, from which there is a direct connection to the public Internet network 4 and via it to the server apparatus 1, so that the person A is also in a connection to the public Internet network 4 and also to the server apparatus 1 Thus the person A can e.g. browse web pages through a MESH connection. Correspondingly, if the person A has made e.g. an agreement about location tracking with the body that maintains the server apparatus 1, information about his/her whereabouts at that time are always conveyed to the server apparatus 1 when the connection is on.

FIG. 2 presents a simplified diagrammatic view of one administration server 1 suited for use in the arrangement according to the invention. The server 1 is a computer that comprises at least connection means 6 for receiving information coming to the server 1 and for sending the information to be sent from the server 1. The administration server 1 additionally comprises at least memory means 7, database means 8, a processor unit 9 and also a user interface 10 for entering information into the server and for receiving information obtainable from the server. The server 1 also comprises a power source 1b that receives it energy externally to enable power supply to the different actuators of the server.

The administration server 1 further comprises a control system 1a, which is fitted to administer, coordinate and control the location tracking arrangement according to the invention. Additionally the control system 1a comprises at least calculation means 11 for processing the emissions impact information of the vehicles 2a-2n received from the remote terminals 2 and for calculating in essentially real-time the location-specific total emissions impact, and also if necessary for guiding the routes of the vehicles 2a-2n to bypass those places in which the emissions impact threatens to grow too high. The same calculation means 11 are fitted to operate such that if emission information is not available, the calculation means 11 monitor and calculate just the congestion information and guide the vehicles 2a-2n to travel less congested routes. The calculation means 11 have available the necessary information recorded in the database means 8 for calculating emissions impacts and for giving directions as well as route alternatives to the remote terminals 2. In place of the calculation means 11, the control system 1a can also comprise its own separate calculation means purely for processing congestion situations and for giving route instructions in relation to them.

The control system 1a also has allocation means 15, by means of which the administration server 1 is fitted to allocate position information and emissions impact information received from the remote terminals 2 as having come specifically from a certain remote terminal 2 and likewise to allocate the directions or other information it gives back to specifically the same remote terminal 2.

The control system 1a also comprises calculation means 12 for automatically making mileage allowance claims made on the basis of position information received from a remote terminal 2. By means of the allocation means 15 mileage allowance claims are fitted to be allocated to a certain specific remote terminal 2. Any necessary information whatsoever, such as a kilometer price, the personal information of the user of the remote terminal, a company, et cetera, is fitted to be recorded for the specific remote terminal in the control system 1a and in the database 8 of it.

The control system 1a also comprises route-forming means 16, which are arranged to calculate the route of a vehicle 2a-2n on the basis of the position information of the GPS data coming from each vehicle. In addition to calculating the route, the route-forming means 16 are arranged to send via a data network, such as via the Internet 4, the route traveled by each vehicle 2a-2n to each vehicle in which the route traveled by the vehicle is arranged to be displayed on the display of the remote terminal 2 of each vehicle 2a-2n on a map template sent to each remote terminal 2 by the route-forming means 16. In a corresponding manner the route-forming means 16 are also if necessary equipped to calculate the position information and routes coming from portable remote terminals 2 and to send to them the route traveled by the carrier of the remote terminal on a map template sent to the remote terminal 2.

In one preferred embodiment of the invention the control system 1a also comprises means 13 for monitoring the whereabouts and adherence to timetable of public transport vehicles, such as buses or trains, and for reporting arrival times at stops. In addition, in a preferred embodiment of the invention the control system 1a comprises tracking means 14 for tracking taxi traffic and for indicating the nearest free taxi to the orderer. In this case the taxis contain remote terminals 2 according to the invention, from which there is a connection to the taxi center, in which the position of each taxi is visible on a map on the basis of the notification of GPS data or the data given by some other corresponding satellite positioning system. When an order comes the system is fitted to locate the nearest free taxis and to show them on the map, in which case the taxi center can send them instructions concerning the order. After this the processing of the order continues normally.

The calculation means 11 of measurement information in the control system 1a of the administration server 1, the calculation means 12 of mileage allowance, the means 13 and the tracking means 14 are referred to later, e.g. in the claims, by the collective term processing means 11-14.

FIG. 3 presents a simplified diagrammatic view of one typical remote terminal 2 that functions as a connection means and is used in the arrangement according to the invention, which remote terminal can be installed e.g. in a vehicle, such as an automobile. Correspondingly an essentially similar or suitably fitted and stripped-down model is suited as a portable, remote terminal 2 e.g. fitting in the pocket. The remote terminal 2 is in principle a computer, which comprises normal computer outfitting with connectors and at least a processor unit 19, processing means 19a for processing, and for sending onwards for recording, or to a wireless network for transmitting, position information and other external information collected by the remote terminal, such as measuring information, a memory unit 20 connected to e.g. an IDE bus and a power source 35 receiving energy from an external source, such as the accumulator of an automobile, as well as an accumulator, battery or fuel cell that functions as a backup power source 34. The remote terminal 2 additionally comprises a user interface 17, which comprises e.g. a display and if necessary a keypad visible on the display with which information is entered into the remote terminal 2. For implementing wireless network functions, the remote terminal 2 further comprises network function means 18 for connecting the remote terminal 2 to a wireless MESH network or to a corresponding network. The network function means 18 is thus equipped so that the remote terminal 2 operates also as a router of the wireless network.

The remote terminal 2 also comprises connection means 28 for wirelessly connecting the remote terminal 2 to available networks. The connection means 28 are connected to the remote terminal e.g. with a PCI bus. The connection means 28 are e.g. connection means 29 to a telecommunications network, such as a network enabling a GPRS connection, connection means 30 to a WLAN network and connection means 31 to a WiMAX network. The remote terminal 2 also comprises a connection means 32 for forming a wireless Bluetooth connection.

Likewise the remote terminal 2 comprises a plurality of connection means for wirelessly connecting the remote terminal to another apparatus. These types of connections means are e.g. different serial bus elements, such as USB connection means 23 and other conventional serial bus means 24. In the arrangement according to the invention e.g. an external positioning apparatus, such as a GPS apparatus 22, is connected to the remote terminal 2 via a USB connector for receiving satellite positioning information, such as GPS data, or corresponding, and the clock time. Correspondingly, e.g. the power switch 25 of the remote terminal 2, the function button 26 that is the GPD activation switch, the signal lamp 27 indicating that the power is on and the signal lamps 27a of the GPS positioning apparatus 22, are connected to a conventional serial bus.

In the solution according to the example, a sensor 36 that measures the emissions impact of a vehicle 2a-2n is also connected to a conventional serial bus 24. The sensor 36 could just as well be connected e.g. to the USB port 23 or to some other suitable input connector in the apparatus. The measuring head of the sensor 36 is connected e.g. to the engine or to the exhaust system of the vehicle 2a-2n.

The sensor 36 that measures the emissions impact can be some other measuring element or sensor, which is fitted to measure or to collect some other desired information external to the remote terminal. The sensor 36 can here also represent a plurality of different sensors, which are fitted to measure the different external measuring points of the remote terminal 2 and to collect measuring information about them.

The function button 26 reports the work mode of the remote terminal 2, on the basis of which work mode the remote terminal 2 is fitted to send different information containing a different status to the server. The work mode can be e.g. a work run, for which mileage allowance is calculated or the work mode can be a leisure run, for which mileage allowance is not calculated.

When the remote terminal 2 is in active use, the function means in the remote terminal 2 are switched on, which function means endeavor to actively keep a connection to the network and to send GPS positioning information and other collected information via the network to the administration server 1. If a connection is not immediately found, the remote terminal 2 comprises means for implementing this and for recording positioning information and other collected information temporarily in the own memory 20 of the remote terminal 2 and also after a connection is formed for sending the recorded positioning information and other collected information to the administration server 1. In this way the route traveled by a vehicle 2a-2n or other moving object is conveyed as accurately as possible to the correct administration server 1. If a memory 20 were not available, a long connection break would easily distort the route because when the connection returned the first new positioning point would be connected directly to the last positioning point before the connection break. This route, which is shown “as the crow flies”, is not necessarily correct because the vehicle 2a-2n or other moving object could have meandered a lot during the connection break.

Other wireless connection means are at least a smartcard reader apparatus 21, which is connected e.g. to the IDE bus of the remote terminal, to a serial bus or to some other suitable connection point for receiving the identification information of the driver. Likewise connection means intended for wireless connections are Ethernet connectors 33 and other corresponding connectors.

In the arrangement according to the invention the remote terminal 2 according to one embodiment is e.g. an apparatus suited as a connection means that can easily be installed into moving vehicles 2a-2n, which apparatus comprises means for receiving GPS position coordinates or corresponding position coordinates, and which is fitted to automatically measure by means of the GPS position coordinates or corresponding the kilometers driven on a work runs with the vehicles 2a-2n when the function button 26 is set to the mode that means a work run. Both the remote terminal 2 disposed in vehicles in a fixed position and one intended for carrying along is fitted to send position coordinates and other collected information at regular intervals wirelessly, e.g. via a GPRS connection, a WLAN connection or other corresponding connection, to the administration server 1 for recording and processing. The remote terminals 2 are supervised, controlled, updated and coordinated by means of the control system 1a in the administration server 1, to which customers have a connection via a data network, e.g. the Internet 4.

The remote terminal 2 is fitted to use as its platform effective and highly developed wireless Roaming Mesh technology with a Linux operating system. The operating system comprises support for automatic updates over a secure network to everywhere in the world. All the wireless connections supported by the arrangement are fitted between themselves such that they can be on simultaneously or each separately or crosswise between themselves. The remote terminal 2 is also equipped to distribute an Internet connection to the remote terminals 2 of other vehicles 2a-2n or to portable remote terminals 2. In this case the remote terminal 2 can when suitably equipped be used as a browser or the remote terminal 2 functions only as a router or as a base station e.g. for a portable computer, with which access is obtained via the remote terminal 2 to a wireless Internet connection. In addition, the remote terminal 2 comprises means for using a VoIP phone by means of the remote terminal 2.

In summary, the use according to one preferred embodiment of the location tracking arrangement according to the invention for automatic calculation of mileage allowance is presented. When a person, into whose vehicle the aforementioned remote terminal 2 has been installed and who is duly registered in the control arrangement 1a and in the Wiana register of the Wiana server 3, leaves in his/her car on a run for which he/she is entitled to receive mileage allowance, he/she switches the remote terminal 2 on and when setting off on the journey presses the function button 26 on the remote terminal, in which case the remote terminal 2 receives information that the run in question is reimbursable. In this case the remote terminal 2 takes note of the position information available by means of the GPS apparatus 22 and sends it to the administration server 1, where the administration server identifies the remote terminal 2 and registers the position information it receives and also starts to calculate the route by means of the calculation means 12 and the route-forming means 16. The administration server 1 places the route it has calculated in a suitable map template by means of the route-forming means 16 and sends the map template with the route to the aforementioned remote terminal 2, which receives the map template with the route on its display, if the remote terminal 2 is provided with a display.

When the remote terminal 2 is active the distance traveled by an automobile is monitored with the GPS apparatus 22 essentially continuously and the new position information is sent to the administration server 1 at regular intervals, e.g. at intervals of 5 seconds. If the remote terminal 2 does not at some moment obtain a connection to the administration server 1 with any connection means, the remote terminal 2 records position information in its own memory 20 and continuously tries for a connection. When the connection is again obtained, the remote terminal 2 sends also the position information in the memory to the administration server 1. When the reimbursable run has finished, the function button 26 is returned to its normal mode, in which case the remote terminal 2 does not send the type of position information on which reimbursement would be calculated to the administration server 1. When the administration server 1 receives information from the remote terminal 2 that a reimbursable run has finished, it automatically calculates by means of the calculation means 12 the mileage allowances of the driving trip in question by means of the basic information that is in its database concerning the remote terminal 2 in question.

When the remote terminal 2 is active, irrespective of whether a work run is involved or not, the administration server 1 receives the position information of the vehicles 2a-2n essentially continuously and thus knows exactly where the vehicle is at any time. This information can be used as it is also for controlling congestions. For the purposes of this function the control system 1a of the administration server 1 comprises at least calculation means 11 or other suitable means for processing in essentially real-time the position information of all the vehicles 2a-2n in the system received from the remote terminals 2 and for identifying congestion situations. When congestion is detected in some area on the basis of the information processed in this way, the calculation means 11 or other suitable calculation means deliver information about it e.g. to the vehicles approaching the area and automatically give instructions for bypassing the congestion.

When the remote terminals 2 are additionally provided with a sensor 36, connected to the engine or the exhaust system of the vehicle 2a-2n, which sensor measures the emissions impact of a vehicle 2a-2n, the monitoring of congestion situations can also be utilized from the viewpoint of environmental protection. In this case the remote terminals 2 collect essentially continuously the emissions impact information of the vehicle 2a-2n and send the information collected in this way along with the position information to the control system 1a of the administration server 1, where the calculation means 11 process in essentially real-time the position information and the emissions impact information that has come from all the vehicles 2a-2n connected to the system and calculate the location-specific total emissions impacts. If the emissions impact in some area threatens to rise too high, the calculation means 11 give information about this via the control system 1a to the vehicles 2a-2n and they guide the vehicles 2a-2n to travel different routes.

As mentioned earlier, the arrangement according to the invention with fixed or mobile remote terminals 2 can be used for many different purposes and in many different ways. In this case remote terminals 2 can e.g. be fixed to load containers or to smaller freight units and thus the passage and whereabouts of freight can be tracked. Likewise the location tracking arrangement according to the invention can be used for ascertaining the whereabouts of stolen vehicles, in which case a suitably adapted remote terminal according to the invention is disposed in some place that is difficult to detect in the vehicle and adjusted to send information about its whereabouts e.g. at the desired intervals. Correspondingly the arrangement for communication and location tracking according to the invention can be used e.g. also for ascertaining the whereabouts of children and joggers as well as the position and routes of other moving people in the manner mentioned above.

It is obvious to the person skilled in the art that the invention is not limited solely to the example described above, but that it may be varied within the scope of the claims presented below. Thus the invention is suited for many other uses than what is presented above. Common to all the applicable uses is that the arrangement comprises at least one administration server and a plurality of remote terminals, which remote terminals comprise at least connection means for sending information to the administration server and for receiving information from the administration server, and which remote terminals comprise if necessary means for collecting, processing and if necessary recording external information of the remote terminal, in which case the external information can be e.g. the position tracking information of the remote terminal received by means of satellite positioning, time information, measuring information given by a measuring sensor connected to the remote terminal, etc.

It is further obvious to the skilled person that the remote terminals can be disposed e.g. in stationary advertising billboards, in which case the remote terminals are provided with means that calculate the vehicles passing the remote terminal and inform the administration server of the number of vehicles. The calculation means can in this case be e.g. an apparatus that transmits a light beam on the first side of the road, and on the second side of the road is an apparatus that receives the aforementioned light beam as well as an apparatus that registers the number of those vehicles that break the light beam when they go past the remote terminal. The calculation means deliver the number measured in this way to the remote terminal for further processing and for transmitting.

It is also obvious to the skilled person that the remote terminals can be disposed in the kind of trucks, onto the sides of the cargo space of which e.g. different advertisements can be affixed. In this case the remote terminals send the position information of the truck essentially all the time to the administration server and thus it is possible to accurately monitor where the trucks move and to compile advertisements and advertisement plans according to it.

1. Arrangement for communication and location tracking, which arrangement comprises at least one or more server apparatuses and a plurality of remote terminals, the position of which is arranged to be located by satellites and which remote terminals comprise at least means for sending information to the server apparatus, characterized in that the means in the remote terminals are equipped to send information concerning the position of the remote terminal and other information collected by the remote terminal wirelessly to the server apparatus, and in that the server apparatus is provided with at least connection means for receiving information coming from the remote terminal, with a database for recording information coming from the remote terminal, with processing means for processing information sent by the remote terminal, and also with a control system for coordinating and controlling the different functions of the arrangement for communication and location tracking.

2. Arrangement according to claim 1, wherein the remote terminal is a computer apparatus provided with at least a processor unit, processing means, a memory and a plurality of different input/output ports, which computer apparatus comprises means for recording position information received by means of satellite positioning and also if necessary measuring information measured with exterior measuring sensors in the memory, as well as means for connecting to a wireless MESH network.

3. Arrangement according to claim 1 or 2, wherein the processing means are fitted to process the position information of the remote terminal and if necessary other external measuring information collected in the remote terminal by means of the measuring sensors.

4. Arrangement according to claim 1, wherein the remote terminal is an apparatus fitted to be carried along with a moving object, which apparatus comprises means for receiving information, such as position information and measuring information.

5. Arrangement according to claim 1, wherein the remote terminal is an apparatus that can be disposed in a vehicle.

6. Arrangement according to claim 1, wherein the control system comprises at least calculation means for processing position information received from the remote terminals and also for calculating the congestion information of the vehicles on the basis of the position information and if necessary for guiding the routes of the vehicles to bypass those places in which the congestion threatens to grow too high.

7. Arrangement according to claim 1, wherein the measuring sensor connected to the remote terminal is fitted to measure the own emissions impact of a vehicle, and in that the processing means are fitted to process the measured emissions impact information.

8. Arrangement according to any of claims 5-7, wherein the server apparatus comprises calculation means are fitted to process the emissions impact information of the vehicles received from the remote terminals and to calculate the location-specific total emissions impact in essentially real-time, and also if necessary to guide the routes of the vehicles to bypass those places in which the emissions impact threatens to grow too high.

9. Arrangement according to claim 1, wherein the remote terminal comprises means for reporting the desired starting point and ending point of the route of a moving object, such as a pedestrian or a vehicle, to the server apparatus via a wireless network.

10. Arrangement according to claim 1, wherein the server apparatus comprises calculation means for automatically making mileage allowance claims calculated on the basis of position information received from a remote terminal and allocation means for allocating allowance claims to a certain specific remote terminal.

11. Arrangement according to claim 1, wherein the arrangement the remote terminals are registered in the Wiana register, by means of which each remote terminal is individualized with its own identification, and in that each remote terminal is marked with the same identification also in the control system.

12. Arrangement according to claim 1, wherein the remote terminal comprises a display and a keypad as a user interface, and in that the control system comprises route-forming means, the route of a moving object, such as a pedestrian or a vehicle calculated by which is arranged to be seen on a map template sent to the display.

13. Arrangement according to claim 1, wherein the remote terminal comprises means for implementing at least a GPRS connection, a WLAN connection, a WiMAX connection and/or a Bluetooth connection from the remote terminal to a wireless network.

14. Arrangement according to claim 1, wherein the control system comprises means for monitoring the whereabouts and adherence to timetable of a public transport vehicle and for reporting arrival times at stops.

15. Arrangement according to claim 1, wherein the control system comprises tracking means for tracking taxi traffic and for indicating the nearest free taxi to the orderer.

16. Arrangement according to claim 1, wherein the remote terminal is connected with a wireline or wirelessly, e.g. with a Bluetooth connection, to a mobile phone, a PDA apparatus or to some other mobile apparatus.

17. Arrangement according to claim 1, wherein the remote terminal is a mobile phone, a PDA apparatus or some other mobile apparatus, which is provided with positioning means or connected to positioning means, into which at least network function means for connecting to a wireless MESH network or corresponding network is integrated.

18. Arrangement according to claim 1, wherein the remote terminal is fixed in its stationary position and provided with means for monitoring the traffic passing by and counting the number, and also for sending the number it detects essentially in real-time to the control system.
